(19) United States
(12) Patent Application Publication
(10) Pub. No.: US 2007/0126708 A1
(43) Pub. Date: Jun. 7, 2007

(54) Method for gesture detection on a touch control bar with button and scroll bar functions

(76) Inventors: Tso-Chieh Yang, Chingshuei Township (TW); Kuan-Chun - Tang, Toufen Township (TW); Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/518,455

(22) Filed: Sep. 11, 2006

(30) Foreign Application Priority Data
Dec. 5, 2005 (TW) 094142838

(51) Int. Cl. G09G 5/00

(52) U.S. Cl. 345/173

(57) ABSTRACT

In a gesture detection method for a touch control bar with button and scroll bar functions, according to the present invention, various gestures such as tap, drag and double tap are determined by detecting an object that touches on the touch control bar, leaves from the touch control bar, and moves on the touch control bar.

### FIELD OF THE INVENTION

The present invention is generally related to a detection method for a touch control bar and, more particularly, to a method for gesture detection on a touch control bar with button and scroll bar functions.

### BACKGROUND OF THE INVENTION

Capacitive touchpad is an input device that allows users to slide their finger or fingers on a smooth panel thereof for cursor movement control. Because of its very small thickness, capacitive touchpad can be designed in slim notebooks, keyboards, digital media players and other devices, and moreover, due to its non-mechanical design it is virtually maintenance free.

The touchpad technologies are widely used in electronic devices, and among these technologies, the touch control bars and the touch control buttons are often combined to set on the panel of consumer electronic products for selecting and moving on a menu, or adjusting the volume and brightness. Conventional electronic products usually set the touch control bar and the touch control buttons separately on their panel. FIG. 1 shows an arrangement of a conventional panel with such structure, in which there are several buttons 100 provided on a panel 105, and a touch control bar 110 is also provided thereon but separated from the buttons 100. Since individual components are employed on the panel 105, the size of the panel 105 is required larger for these components, and the structure of the panel 105 is complicated because of the multiple components. However, consumer electronic products are improved in a trend of small size and light weight, and the sizes of their panels are also required to be minified accordingly. To meet such requirement, various approaches for minifying the panel size are proposed.

Therefore, it is desired a method for gesture detection on a touch control bar with button and scroll bar functions.

### SUMMARY OF THE INVENTION

An object of the present invention is to provide a method for gesture detection on a touch control bar with button and scroll bar functions.

In a gesture detection method for a touch control bar with button and scroll bar functions, according to the present invention, various gestures such as tap, drag and double tap are determined by detecting an object that touches on the touch control bar, leaves from the touch control bar, and moves on the touch control bar.

### BRIEF DESCRIPTION OF DRAWINGS

FIG. 1 shows a conventional panel structure with a touch control bar and control buttons;

FIG. 2 shows a touch control bar with button and scroll bar functions;

FIG. 3 shows a touch control bar divided into several regions defined as virtual buttons;

FIGS. 4A-4C show a detected signal and an output signal of three embodiments in a tap gesture;

FIGS. 5A-5C show a detected signal and an output signal of three embodiments in a drag gesture;

FIGS. 6A-6D show a detected signal and an output signal of four embodiments in a double tap gesture.

### DETAILED DESCRIPTION OF THE INVENTION

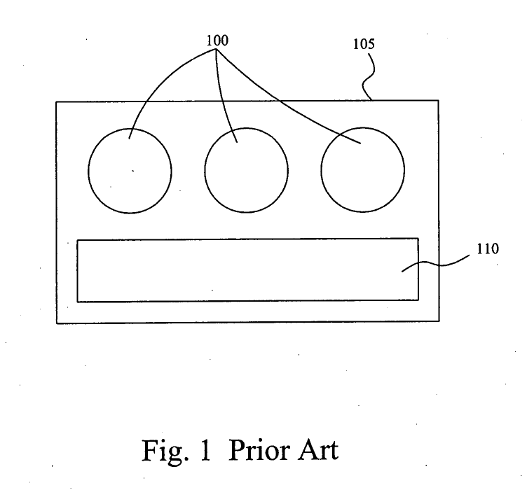

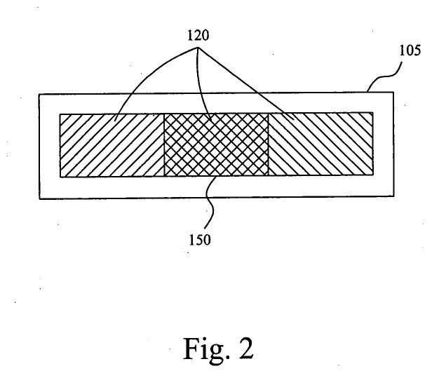

FIG. 2 shows a panel 105 that is much smaller than that shown in FIG. 1 by integrating the control buttons 100 and the touch control bar 110 of FIG. 1 into a touch control bar 150 with touch control buttons 120 thereof.

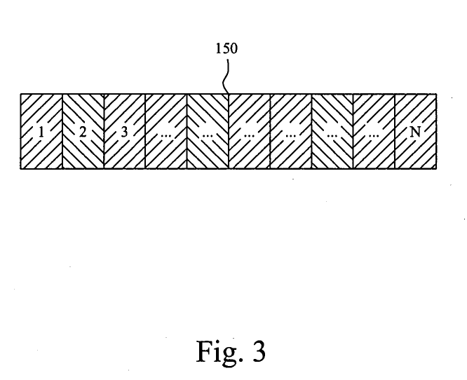

FIG. 3 shows an embodiment to realize the touch control bar 150 of FIG. 2, in which the touch control bar 150 is divided into several sensing regions, and these sensing regions are defined as virtual buttons.

<Detection for a Tap Gesture>

If an object never moves on the touch control bar 150 during the period after it touches the touch control bar 150 and before it leaves the touch control bar 150, it is determined a tap gesture for this operation.

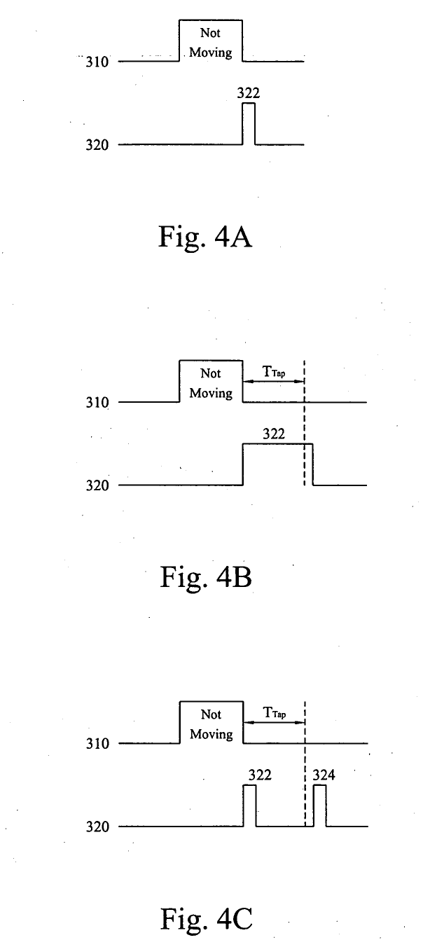

In the detection and determination of a tap gesture, FIG. 4A shows a detected signal 310 and an output signal 320 in a first embodiment. In this case, the output signal 320 includes a gesture signal 322. In the touch control bar 150, when an object is detected touching down to the touch control bar 150, it is produced the detected signal 310 transiting from one level to another level, for example from logical low to logical high. It is further detected and determined which region of the touch control bar 150 is touched by the object and whether or not the object moves on the touch control bar 150. If the object indeed moves on the touch control bar 150, a moving gesture is determined for this operation, and the position information of the object, such as an absolute coordinate, a relative coordinate, or a relative displacement, is produced by the touch control bar 150 in its output signal for this operation; otherwise the detected signal 310 will transit from the logical high to logical low once the object is detected to leave from the touch control bar 150, and then the gesture signal 322 is initiated. The gesture signal 322 may comprise a signal representative of the region of the touch control bar 150 that was touched by the object.

In a second embodiment, as shown in FIG. 4B, the time is further counted after the object leaves the touch control bar 150, and if the counted time reaches a reference time interval T_{Tap}, the gesture signal 322 is terminated. Alternatively, as shown in FIG. 4C, in a third embodiment, a second gesture signal 324 is initiated after the gesture signal 322 is initiated. The gesture signal 324 may be further terminated after the counted time reaches a reference time interval. The gesture signals 322 or 324 may either or both comprise a signal representative of the region of the touch control bar 150 that was touched by the object.

<Detection for a Drag Gesture>

If it is detected the period from the first time an object leaves the touch control bar 150 to the second time an object touches the touch control bar 150 shorter than a reference time interval, and the object does not move on the touch control bar 150 in the first touch but moves in the second touch, this operation is determined a drag gesture.

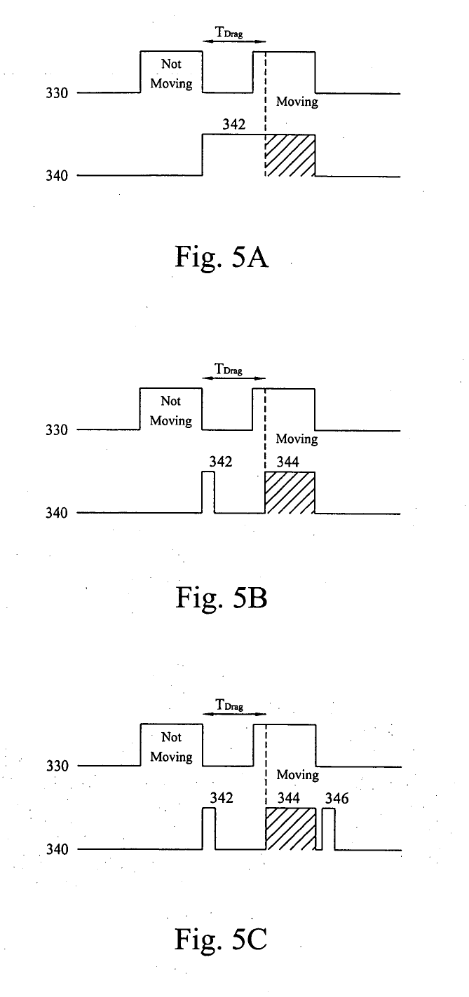

In the detection and determination of a drag gesture, FIG. 5A shows a detected signal 330 and an output signal 340 in a first embodiment. In response to an object touching down to the touch control bar 150 first time, the detected signal 330 transits from logical low to logical high, and it is further determined which region of the touch control bar 150 is touched by the object. Once the object is detected leaving from the touch control bar 150 and it is verified never moving on the touch control bar 150 in the first touch, the detected signal 330 will transit from the logical high back to the logical low and a gesture signal 342 is initiated. After the object leaves the touch control bar 150, the time is counted. If the touch control bar 150 is detected to be touched by an object again before the counted time reaches a reference time interval T_{Drag}, resulting in the detected signal 330 transiting from the logical low to the logical high again, the gesture signal 342 will be maintained and the object will be detected whether or not moving on the touch control bar 150 after this second time the object touches the touch control bar 150. If the object indeed moves on the touch control bar 150, the position information of the object is calculated and sent out by the output signal 340 for this operation. Thereafter, once the object is detected leaving the touch control bar 150, the detected signal 330 transits from the logical high back to the logical low again and the gesture signal 344 is terminated.

In a second embodiment, as shown in FIG. 5B, the output signal 340 includes two gesture signals 342 and 344. In addition to the initiating of the gesture signal 342 after the object is detected leaving the touch control bar 150 first time, the second gesture signal 344 is initiated after the object is verified moving on the touch control bar 150 in the second touch and likewise, the position information of the object after the second time it touches down to the touch control bar 150 is calculated and sent out by the output signal 340. Once the object is detected leaving the touch control bar 150 second time, the detected signal 330 transits from the logical high back to the logical low again and the second gesture signal 344 is terminated. Alternatively, FIG. 5C shows a third embodiment, and in this case, the output signal 340 includes three gesture signals 342, 344, and 346. Once the object is detected leaving the touch control bar 150 second time, resulting in the detected signal 330 transiting from the logical high to the logical low, the third gesture signal 346 is further initiated in addition to the termination of the second gesture signal 344.

Either one or two or all of the gesture signals 342, 344, and 346 shown in FIGS. 5A to 5C may comprise a signal representative of the region of the touch control bar 150 that was touched by the object. Typically, the position information may include an absolute coordinate, a relative coordinate, or a relative displacement of the object.

In yet another embodiment, the step of determining which region of the touch control bar 150 is touched may be carried out alternatively till the second time the object touches the touch control bar 150, so that the information of the touched region of the touch control bar 150 included in the gesture signal 342 or 344 or 346 shown in FIGS. 5A to 5C is exactly the one in the second touch.

<Detection for a Double Tap Gesture>

If the period from a first time an object leaves the touch control bar 150 to a second time an object touches the touch control bar 150 is shorter than a reference time interval, and the object does not move on the touch control bar 150 in these two touches, it is determined a double tap gesture.

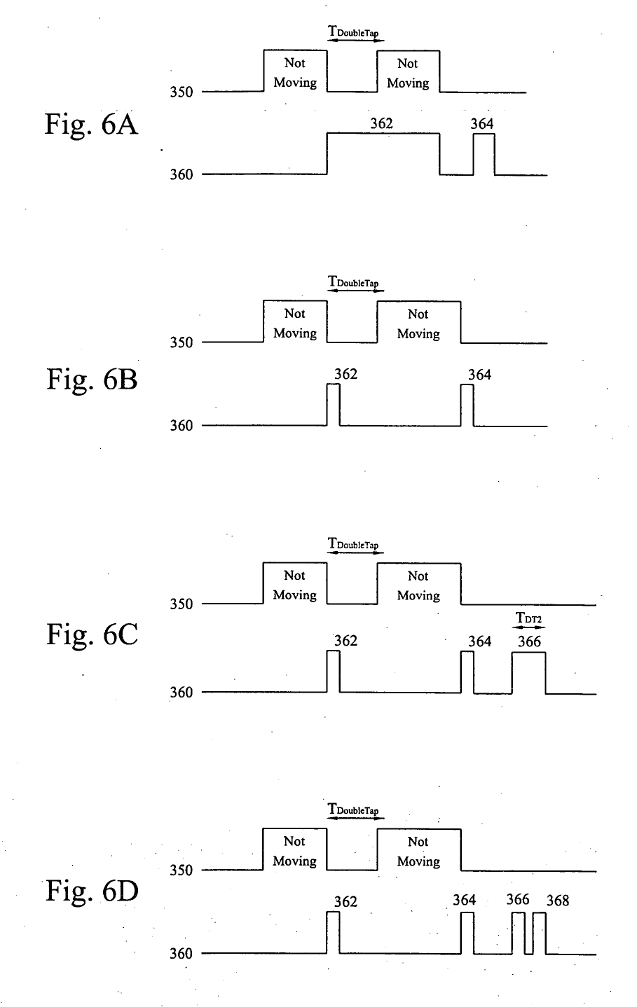

In a first embodiment, as shown in FIG. 6A, if an object is detected touching down to the touch control bar 150 first time, a detected signal 350 will transit from a logical low to a logical high, and it is also detected which region of the touch control bar 150 is touched by the object. When the object is detected leaving the touch control bar 150 and verified never moving on the touch control bar 150 in this first touch, the detected signal 350 will transit from the logical high back to the logical low, and a gesture signal 362 is initiated. The time is counted after the object leaves the touch control bar 150, and if the touch control bar 150 is detected to be touched by an object again before the counted time reaches a reference time interval T_{DoubleTap}, resulting in the detected signal 350 transiting from the logical low to the logical high again, the gesture signal 362 is maintained. Thereafter, if the detected signal 350 transits from the logical high back to the logical low in response to the leaving of the object from the touch control bar 150 again, and the object is verified never moving on the touch control bar 150 after it touches down to the touch control bar 150 the second time, the first gesture signal 362 is terminated and a second gesture signal 364 is initiated.

Alternatively, as shown in FIG. 6B, in addition to the initiating of the first gesture signal 362 in response to the leaving of the object from the touch control bar 150 the first time, the second gesture signal 364 is initiated once the object is detected leaving the touch control bar 150 the second time.

FIG. 6C shows a third embodiment, in which there are three gesture signals 362, 364, and 366 in the output signal 360. In this case, when an object is detected leaving the touch control bar 150 the second time, the detected signal 350 transits from the logical high to the logical low, the second gesture signal 364 is initiated, and the third gesture signal 366 is further initiated thereafter. It may further terminate the third gesture signal 366 when a reference time interval T_{DT2} is passed after initiating of the third gesture signal 366. In yet another embodiment, as shown in FIG. 6D, an output signal 360 includes four gesture signals 362, 364, 366, and 368. After initiating the second gesture signal 364, the third and fourth gesture signals 366 and 368 are initiated in order instead of the single gesture signal 366 as shown in FIG. 6C.

Either one or more of the gesture signals 362, 364, 366, and 368 shown in FIGS. 6A to 6D may comprise a signal representative of the region of the touch control bar 150 that was touched by the object.

In the above embodiments, the absolute coordinate is referred to a coordinate value generated with a fixed position (e.g., the center or a corner of the touch control bar 150) as the original point, the relative coordinate is referred to a coordinate value generated with a relative position (e.g., the position first touched by the object on the touch control bar 150) as the original point, and the relative displacement is referred to a displacement measure relative to the original point.

As illustrated by the above embodiments, various gestures operating on a touch control bar are confirmed with the variation of the sensed capacitance and by determining whether or not the object moves on the touch control bar, and it is therefore more convenient when using the touch control bar.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as string forth in the appended claims.

What is claimed is:

1. A method for gesture detection on a touch control bar with button and scroll bar functions, the touch control bar having a plurality of regions, the method comprising the steps of:
detecting whether or not the touch control bar suffers an object touching down thereto;
determining which one of the plurality of regions is touched if it is detected an object touching down to the touch control bar in the previous detecting step;
detecting whether or not the touch control bar suffers an object moving thereon after the one of the plurality of regions is determined in the previous determining step; and
determining a position information related to the object moving if it is detected in the previous detecting step, otherwise initiating a gesture signal in response to an object leaving from the touch control bar.

2. The method of claim 1, wherein the position information comprises a data including an absolute coordinate, a relative coordinate, or a relative displacement.

3. The method of claim 1, wherein the gesture signal comprises a signal representative of the one of the plurality of regions upon the object touching.

4. The method of claim 1, further comprising the step of terminating the gesture signal after a reference time interval from the initiating of the gesture signal.

5. The method of claim 1, further comprising the step of initiating a second gesture signal after the initiating of the first gesture signal.

6. The method of claim 5, wherein the second gesture signal is initiated after a reference time interval from the initiating of the first gesture signal.

7. The method of claim 5, wherein the second gesture signal comprises a signal representative of the one of the plurality of regions upon the object touching.

8. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers an object leaving therefrom if it is detected a first object touching down to the touch control bar in the previous detecting step;
verifying the touch control bar did not suffer an object moving thereon between the first object touching and the object leaving if it is detected an object leaving from the touch control bar in the previous detecting step;
counting a time from the object leaving till a second object touching down to the touch control bar;
verifying the counted time is shorter than a reference time interval;
verifying the touch control bar suffers an object moving thereon after the second object touching if the counted time is shorter than the reference time interval in the previous verifying step; and
initiating a gesture signal after it is verified an object moving on the touch control bar in the previous verifying step.

9. The method of claim 8, further comprising the step of determining which one of the plurality of regions is touched upon the first or second object touching.

10. The method of claim 8, wherein the gesture signal comprises a signal representative of the one of the plurality of regions upon the second object touching and a position information related to the object moving.

11. The method of claim 10, wherein the position information comprises a data including an absolute coordinate, a relative coordinate, or a relative displacement.

12. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers a first object leaving therefrom if it is detected a first object touching down to the touch control bar in the previous detecting step;
verifying the touch control bar did not suffer any object moving thereon between the first object touching and the first object leaving if it is detected a first object leaving from the touch control bar in the previous detecting step;
initiating a gesture signal after it is verified no object moving on the touch control bar in the previous verifying step;
counting a time from the first object leaving till a second object touching down to the touch control bar;
verifying the counted time is shorter than a reference time interval;
maintaining the gesture signal if the counted time is shorter than the reference time interval in the previous verifying step;
detecting whether or not the touch control bar suffers any object moving thereon during the gesture signal is maintained;
determining a position information related to the object moving if it is detected in the previous detecting step; and
terminating the gesture signal once the touch control bar suffers a second object leaving therefrom.

13. The method of claim 12, further comprising the step of determining which one of the plurality of regions is touched upon the first or second object touching.

14. The method of claim 12, wherein the gesture signal comprises a signal representative of the one of the plurality of regions upon the first or second object touching and the position information.

15. The method of claim 12, wherein the position information comprises a data including an absolute coordinate, a relative coordinate, or a relative displacement.

16. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers a first object leaving therefrom if it is detected a first object touching down to the touch control bar in the previous detecting step;
verifying the touch control bar did not suffer any object moving thereon between the first object touching and the first object leaving if it is detected a first object leaving from the touch control bar in the previous detecting step;
initiating a first gesture signal after it is verified no object moving on the touch control bar in the previous verifying step;
counting a time from the first object leaving till a second object touching down to the touch control bar;
verifying the counted time is shorter than a reference time interval;
detecting whether or not the touch control bar suffers any object moving thereon if it is verified the counted time is shorter than the reference time interval in the previous verifying step;
initiating a second gesture signal if it is detected an object moving on the touch control bar in the previous detecting step; and
terminating the second gesture signal once the touch control bar suffers a second object leaving therefrom.

17. The method of claim 16, further comprising the step of determining which one of the plurality of regions is touched upon the first or second object touching.

18. The method of claim 16, wherein the first gesture signal comprises a signal representative of the one of the plurality of regions upon the first object touching.

19. The method of claim 16, wherein the second gesture signal comprises a signal representative of the one of the plurality of regions upon the second object touching and a position information related to the object moving.

20. The method of claim 19, wherein the position information comprises a data including an absolute coordinate, a relative coordinate, or a relative displacement.

21. The method of claim 16, further comprising initiating a third gesture signal after the terminating of the second gesture signal.

22. The method of claim 21, wherein the third gesture signal comprises a signal representative of the one of the plurality of regions upon the second object touching.

23. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers a first object leaving therefrom if it is detected a first object touching down to the touch control bar in the previous detecting step;
verifying the touch control bar did not suffer any object moving thereon between the first object touching and the first object leaving if it is detected a first object leaving from the touch control bar in the previous detecting step;
counting a time from the first object leaving till a second object touching down to the touch control bar;
verifying the counted time is shorter than a reference time interval;
verifying the touch control bar did not suffer any object moving thereon between the second object touching and a second object leaving therefrom if the counted time is shorter than the reference time interval in the previous verifying step; and
initiating a gesture signal after the second object leaving if it is verified no object moving on the touch control bar in the previous verifying step.

24. The method of claim 23, further comprising the step of determining which one of the plurality of regions is touched upon the first or second object touching.

25. The method of claim 23, wherein the gesture signal comprises a signal representative of the one of the plurality of regions upon the first or second object touching.

26. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers a first object leaving therefrom if it is detected a first object touching down to the touch control bar in the previous detecting step;
verifying the touch control bar did not suffer any object moving thereon between the first object touching and the first object leaving if it is detected a first object leaving from the touch control bar in the previous detecting step;
initiating a first gesture signal after it is verified no object moving on the touch control bar in the previous verifying step;
counting a time from the first object leaving till a second object touching down to the touch control bar;
verifying the counted time is shorter than a reference time interval;
maintaining the first gesture signal if the counted time is shorter than the reference time interval in the previous verifying step;
detecting whether or not the touch control bar suffers any object moving thereon during the first gesture signal is maintained;
terminating the first gesture signal once the touch control bar suffers a second object leaving therefrom and no object moving is detected in the previous detecting step; and
initiating a second gesture signal after the terminating of the first gesture signal.

27. The method of claim 26, further comprising the step of determining which one of the plurality of regions is touched upon the first or second object touching.

28. The method of claim 26, wherein the first gesture signal comprises a signal representative of the one of the plurality of regions upon the first object touching.

29. The method of claim 26, wherein the second gesture signal comprises a signal representative of the one of the plurality of regions upon the second object touching.

30. A method for gesture detection on a touch control bar with button and scroll bar functions, the touch control bar having a plurality of regions, the method comprising the steps of:
detecting whether or not the touch control bar suffers a first object touching down thereto;
detecting whether or not the touch control bar suffers a first object leaving therefrom if it is detected a first object touching down to the touch control bar in the previous detecting step;
verifying the touch control bar did not suffer any object moving thereon between the first object touching and the first object leaving if it is detected a first object leaving from the touch control bar in the previous detecting step;
initiating a first gesture signal after it is verified no object moving on the touch control bar in the previous verifying step;
counting a time from the first object leaving till a second object touching down to the touch control bar;
verifying the counted time is shorter than a reference time interval;
detecting whether or not the touch control bar suffers any object moving thereon if it is verified the counted time is shorter than the reference time interval in the previous verifying step;
verifying the touch control bar did not suffer any object moving between the second object touching and a second object leaving from the touch control bar; and
initiating a second gesture signal after the second object leaving from the touch control bar if it is verified no object moving on the touch control bar in the previous verifying step.

31. The method of claim 30, further comprising the step of determining which one of the plurality of regions is touched upon the first or second object touching.

32. The method of claim 30, wherein the first gesture signal comprises a signal representative of the one of the plurality of regions upon the first object touching.

33. The method of claim 30, wherein the second gesture signal comprises a signal representative of the one of the plurality of regions upon the second object touching.

34. The method of claim 30, further comprising the step of initiating a third gesture signal after the initiating of the second gesture signal.

35. The method of claim 34, wherein the third gesture signal comprises a signal representative of the one of the plurality of regions upon the second object touching.

36. The method of claim 34, further comprising the step of terminating the third gesture signal after a reference time interval from the initiating of the third gesture signal.

37. The method of claim 30, further comprising the steps of:
initiating a third gesture signal after the initiating of the second gesture signal; and
initiating a fourth gesture signal after the initiating of the third gesture signal.

38. The method of claim 37, wherein the third gesture signal comprises a signal representative of the one of the plurality of regions upon the second object touching.

39. The method of claim 37, wherein the fourth gesture signal comprises a signal representative of the one of the plurality of regions upon the second object touching.
